(19) United States
(12) Patent Application Publication
(10) Pub. No.: US 2013/0276857 A1
(43) Pub. Date: Oct. 24, 2013

(54) Electric and Mechanical Interconnection System of Photoelectrochemical Cells Modules

(71) Applicant: Dyepower, Rome (IT)

(72) Inventors: Giovanni ASCIONE, Rome (IT); Alessandro LANUTI, Rome (IT); Simone MASTROIANNI, Rome (IT); Stefano PENNA, Rome (IT); Andrea REALE, Rome (IT); Gabriele ZUCCARO, Rome (IT)

(21) Appl. No.: 13/917,871

(22) Filed: Jun. 14, 2013

Related U.S. Application Data
(63) Continuation of application No. PCT/IT2011/000404, filed on Dec. 15, 2011.

(30) Foreign Application Priority Data
Dec. 15, 2010 (IT) RM 2010 A 000661

(51) Int. Cl. H01G 9/20

(52) U.S. Cl. CPC H01G 9/2081
USPC 136/244

(57) ABSTRACT

The present invention regards a module (10) of photoelectrochemical cells, comprising at least a flat shape substrate (11), with two opposing surfaces and a lateral edge, joining said opposing surfaces along the respective perimeters, on one of said surfaces of said substrate (11) being placed in succession a conductive coating (15) and one or more photoelectrochemical cells (13), said module (1) comprising moreover a first electrode (14) of the whole module and a second electrode (17) of the whole module, wherein said substrate (11) has in correspondence of at least a portion of said lateral edge, means (14, 17, 24, 25, 29) for electrical connection and mechanical coupling with a side by side placed module (10) of the same type.

The invention further refers to an electrical and mechanical interconnection system of photoelectrochemical cell modules (10) as previously defined.

The present invention concerns an electrical and mechanical interconnection system of photoelectrochemical cell modules or DSSC (dye-sensitized solar cells).

More particularly, the invention is related to the structure of said electrical interconnection system, suitable to connect side by side placed photovoltaic modules of DSSC cells.

DSSC cells are photovoltaic cells consisting of a substrate supported multilayer structure, more often, sandwiched between two substrates. Typically, said substrates consist of transparent materials (preferably glass, as well as PET or PEN) and are coated, on the side towards the inside of multilayer structure, with an electrically conductive also transparent layer (generally a transparent conductive oxide, preferably fluorine doped tin oxide or alloy made of tin oxide and indium oxide, named respectively FTO and ITO).

Between said two substrates there are arranged one or more electrically series and/or parallel connected photoelectrochemical cells, each thereof being constituted by a photoelectrode (anode), located on the conductive coating of either substrates; a counterelectrode (cathode), located on the conductive coating of the other substrate and an electrolyte interposed between said photoelectrode and counterelectrode. In particular, the photoelectrode generally consists of a porous high band-gap semiconductor material, as for example titanium oxide or zinc oxide supporting the active material, consisting of a dye suitable to electron transfer as a result of photon absorption. The counterelectrode generally consists of platinum, while the electrolytic solution is generally made up of iodine (I)₂ and lithium Iodide (Lip.

Photoelectrochemical cells of this type are described, for example, in U.S. Pat. No. 4,927,721; materials used in this type of cells are described, for example, in U.S. Pat. No. 5,350,644.

Due to the nature thereof, individual cells of this type are unable to generate tension and/or current levels suitable to meet requirements of most possible applications the photoelectrochemical cells are designed for.

In order to overcome these disadvantages it is therefore necessary series or parallel to connect a plurality of photoelectrochemical cells. Practically, a photoelectrochemical module is realized with same substrates, that is, many photoelectrochemical cells are side by side placed, generally, but not necessarily, photoelectrode being placed in correspondence of either substrates and counterelectrode in correspondence of the opposing substrate, said photoelectrochemical cells being then electrically series and/or parallel connected by means of the layer of conductive coating occurring on every substrate and, optionally, according to desired connection type, by means of a plurality of integrated connection elements on said substrate, as made during module realization.

The size of said photovoltaic modules of photoelectrochemical cells are also limited resulting in that fact that, in order to meet desired requirements, also the modules of photoelectrochemical cells must be series and/or parallel connected.

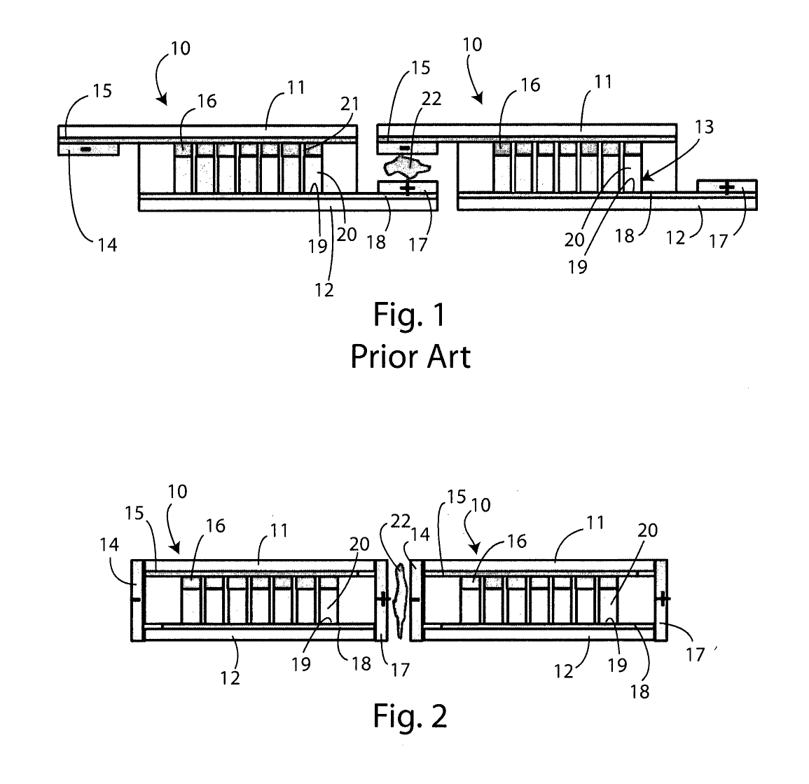

With reference to FIG. 1, in order the electrical and mechanical interconnection of two side by side placed modules 10, according to known art it is proposed to realize every module 10 so that substrates 11, 12, between which photoelectrochemical cells 13 are arranged, are staggered, so to be easy accessible, on one side of module 10, through a first electrode 14 made with a stripe of highly conductive material, the layer of conductive coating 15 of substrate 11 in contact with photoelectrodes 16 of photoelectrochemical cells 13, constituting the anode or negative electrode of whole photovoltaic module 10; and on the opposing side, through a second electrode 17 as well as made with a stripe of highly conductive material, the layer of conductive coating 18 of substrate 12 in contact with counterelectrode 19 of photoelectrochemical cells 13, constituting the cathode or positive electrode of whole photovoltaic module 10. FIG. 1 also shows electrolyte 20 inside of each photoelectrochemical cell 13, as well as encapsulating material 21 sealing each individual cell, preventing the electrolyte from dispersing.

The module interconnection is materially carried out electrically and mechanically connecting, by means of welding or interposing a conductive resin connection element, the electrode 14 of the anode of a first module 10 with the electrode 17 of the cathode of a second module 10 sided to the first, for series module connection, or the respective cathodic electrodes 17 or respective anodic electrodes 14 of two side by side placed modules, for parallel modules connection, respectively. This type of module interconnection suffers from the disadvantage that it is necessary a fraction of every module to be dedicated to interconnection requirements, that is an area in proximity of each side of the module designed to be interconnected with a next module, creating an inactive zone that not only results in a lower energy production for a given area, but also visually alters the aesthetic uniformity of photoelectrochemical cell active area.

Moreover, at current state of the art, the presence of substrate staggering result in a critical assembly step of the module. A module of photoelectrochemical cells, in fact, is realized following a procedure involving, like first step, the application of a layer of conductive coating (preferably FTO or ITO) on one of the two surfaces of each substrate that will constitute the module, then it follows the local removal of stripes of conductive coating from substrates, in order to create electrically isolated areas, each designed for a different photoelectrochemical cell. It follows the realization of holes, one for each photoelectrochemical cell, the injection of liquid electrolyte and successively the cleaning of substrates by washing with acetone and ethanol. At this point the baking (firing) of substrates is carried out and, after cooling, on both substrates the tracks of conductive material are deposited that will serve in order the photoelectrochemical cells to be connected, and also, in proximity of one of the edges of every substrate, those which will constitute the cathodic and anodic electrodes of whole module. It follows a step of track drying, that successively are placed on respective substrates (already equipped with contacts), the material of photoelectrode (preferably TiO₂) and counterelectrode (preferably platinum). It follows the baking of substrates at 500-520° C. (obtaining the sintering of the conductive material of the opposing tracks of the connection element) and dyeing of the photoelectrode. Therefore, before to proceed with the closing step, the encapsulating material is applied on the counterelectrode. Successively, said two substrates, being maintained staggered, are coupled so that the cathodic and anodic electrodes of the module are easy accessible from outside. At last, for the completion of the module, the electrolyte is inserted.

By analyzing the procedure of realization of a photovoltaic module of this type it is apparent the need to prepare all the realization steps taking into consideration the successive staggered assembly of two substrates. A greater criticality not only for assembly steps, but also for all previous realization steps of the single photoelectrochemical cells results.

In the light of above, it is apparent the need to provide for an electrical and mechanical interconnection system of photoelectrochemical cell modules not losing a fraction of every module for interconnection requirements, i.e. it does not result in a lower production of energy for a given area and not alter the aesthetic uniformity of photoelectrochemical cell active area.

In this context the solution according to the present invention, aiming to supply an electrical and mechanical interconnection system of photoelectrochemical cell modules having as the object to maximize the active area of the panel consisting of interconnected modules, but also that of individual modules, is disclosed.

These and other results are obtained according to the present invention proposing an electrical and mechanical interconnection system of photoelectrochemical cell modules with not staggered glasses, that is consisting of interconnections among side by side placed modules realized directly on the edge of the modules.

The object of the present invention is therefore to realize an electrical and mechanical interconnection system of photoelectrochemical cell modules allowing to overcome the limits of the solutions according to known art and obtain the technical results as previously described.

A further object of the invention is that said interconnection system can be realized at substantially reduced costs.

Last object of the invention is to realize an electrical and mechanical interconnection system of photoelectrochemical cell modules that is substantially simple, safe and reliable.

It is therefore a first specific object of the present invention a module of photoelectrochemical cells, comprising at least a flat shape substrate, with two opposing surfaces and a lateral edge joining said opposing surfaces along the respective perimeters, on one of said surfaces of said substrate being placed in succession a conductive coating and one or more photoelectrochemical cells, said module comprising moreover a first electrode of the whole module and a second electrode of the whole module, wherein said substrate has in correspondence of at least a portion of said lateral edge means for electrical connection and mechanical coupling with a side by side placed module of the same type.

In particular, according to the invention, said module of photoelectrochemical cells can comprise a first substrate and a second substrate, respectively equipped, on mutually opposing surfaces, with a first layer of said conductive coating of said first substrate and second layer of said conductive coating of said second substrate, between which one or more photoelectrochemical cells are arranged or, a first electrode of the whole module, electrically connected to said first layer of conductive coating and electrically isolated from said second layer of conductive coating and second electrode of the whole module, electrically connected to said second layer of conductive coating and electrically isolated from said first layer of conductive coating, wherein said first substrate and said second substrate are each to other coupled with the respective lateral aligned edges, defining a module with substantially straight lateral edges, said means of electrical connection and mechanical coupling with side by side placed module of the same type comprising said first electrode of the whole module and said second electrode of the whole module placed in correspondence of two opposing portions of said lateral edge of said module.

Preferably, according to the invention, said means of electrical connection and mechanical coupling with side by side placed module of the same type in correspondence of said lateral edge comprises at least a portion of said lateral edge of said at least a substrate with a ground edge.

Moreover, again according to the invention, said means of electrical connection and mechanical coupling with a side by side placed module of the same type in correspondence of said lateral edge involves that said at least one substrate has a silver or other material layer as an adjuvant for welding of a previously tin plated copper and silver ribbon i.e. it makes more effective the interposing of a conductive resin or a wrinkled portion in correspondence of said lateral edge and/or said at least a ground edge.

Further it is a second specific object of the present invention an electrical and mechanical interconnection system of photoelectrochemical cell modules, as previously defined, wherein the lateral edge on a portion of which is arranged an electrode of a first module is coupled mechanically with the lateral edge on a portion of which is arranged an electrode of second side by side placed module to said first module along a portion of said lateral edge, that can coincide or not with said portion whereon is arranged said electrode, thus series or parallel connecting both electrically and mechanically said side by side placed modules, constituting a rigid structure of side by side placed modules.

Preferably, according to the invention, said electrical and mechanical connection among said modules side by side placed along the respective lateral edges is constituted by welding or a connection element made of conductive resin or metal, arranged among lateral edges of said side by side placed modules.

More preferably, according to the invention, said metal connection component is a previously tin plated copper and silver ribbon welded by joule effect or magnetic induction or according to equivalent technique.

From above it is apparent the effectiveness of electrical and mechanical interconnection system of photoelectrochemical cell modules of the present invention, allowing to maximize the active to inactive area ratio of the panel (aperture ratio), and therefore, for a given width of a module string, to increase the number of cells. Thus the energy produced using the photovoltaic device is increased compared to known standard connection technique.

In addition the electrical and mechanical interconnection system of photoelectrochemical cell modules of the present invention allows to improve the aesthetic aspect of the device, as the reduction of the dimensions of the electrodes constituting the anode and the cathode of every module, obtained according to known art by means of silver flat stripes, exalts the continuous succession of only photoelectrochemical cells.

Moreover, the size reduction of the electrodes represents an indispensable element for the transparency of the panel consisting of photovoltaic module set.

The present invention now will be described, by an illustrative, but not limitative way, according to a preferred embodiment thereof, with particular reference to the enclosed drawings, wherein:

FIG. 1 shows schematically a configuration of electrical and mechanical interconnection of two modules of photoelectrochemical cells according to known art,

FIG. 2 shows schematically a configuration of electrical and mechanical interconnection of two modules of photoelectrochemical cells according to a first embodiment of the present invention,

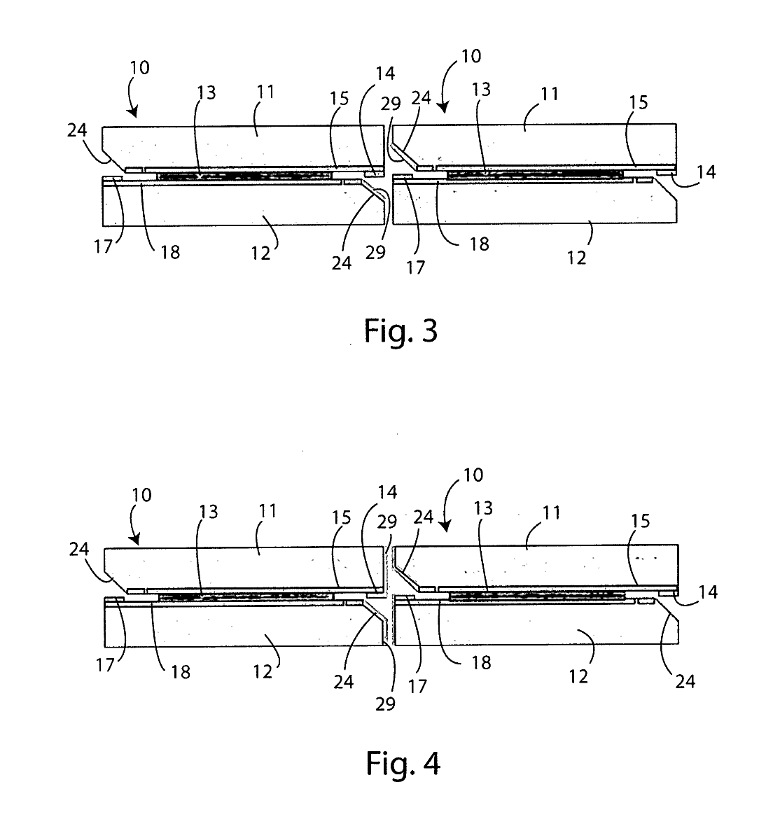

FIG. 3 shows schematically a configuration of electrical and mechanical interconnection of two modules of photoelectrochemical cells according to a second embodiment of the present invention,

FIG. 4 shows schematically a configuration of electrical and mechanical interconnection of two modules of photoelectrochemical cells according to a third embodiment of the present invention,

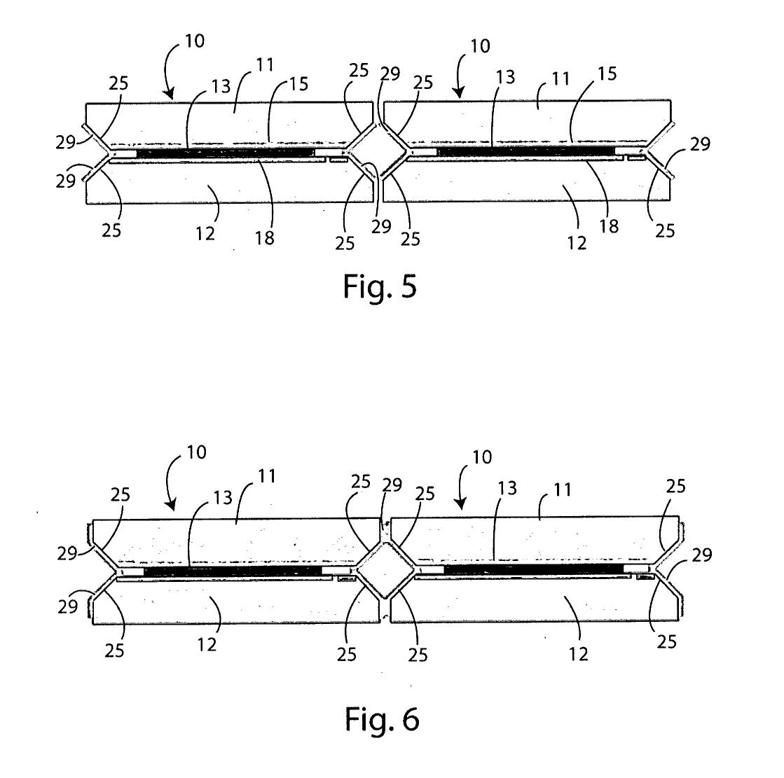

FIG. 5 shows schematically a configuration of electrical and mechanical interconnection of two modules of photoelectrochemical cells according to a fourth embodiment of the present invention,

FIG. 6 shows schematically a configuration of electrical and mechanical interconnection of two modules of photoelectrochemical cells according to a fifth embodiment of the present invention,

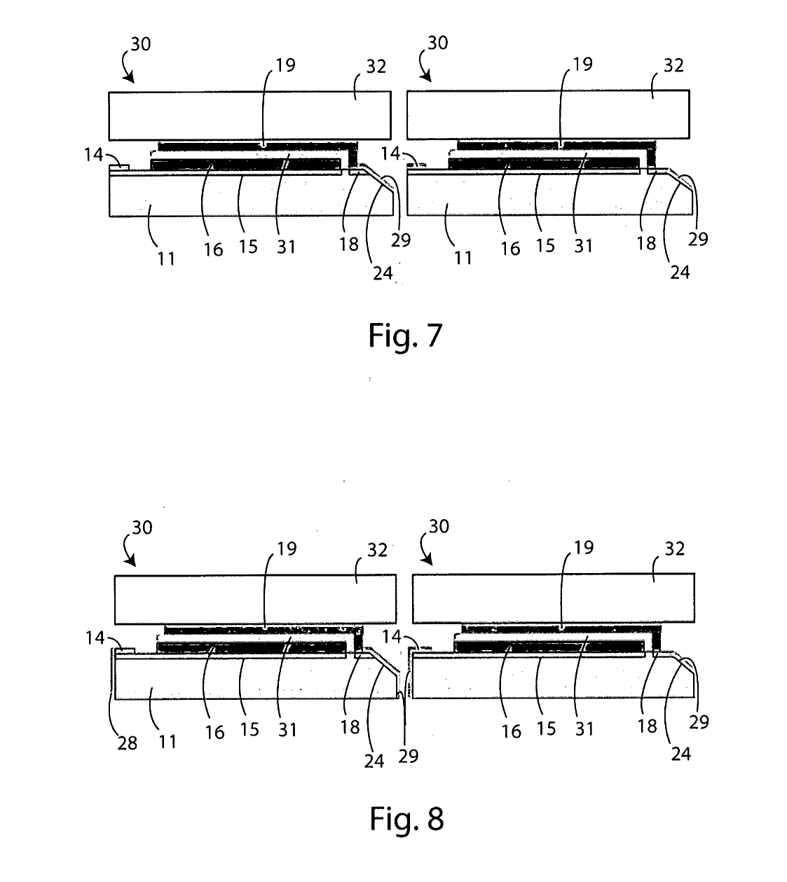

FIG. 7 shows schematically a configuration of electrical and mechanical interconnection of two modules of photoelectrochemical cells according to a sixth embodiment of the present invention,

FIG. 8 shows schematically a configuration of electrical and mechanical interconnection of two modules of photoelectrochemical cells according to a seventh embodiment of the present invention,

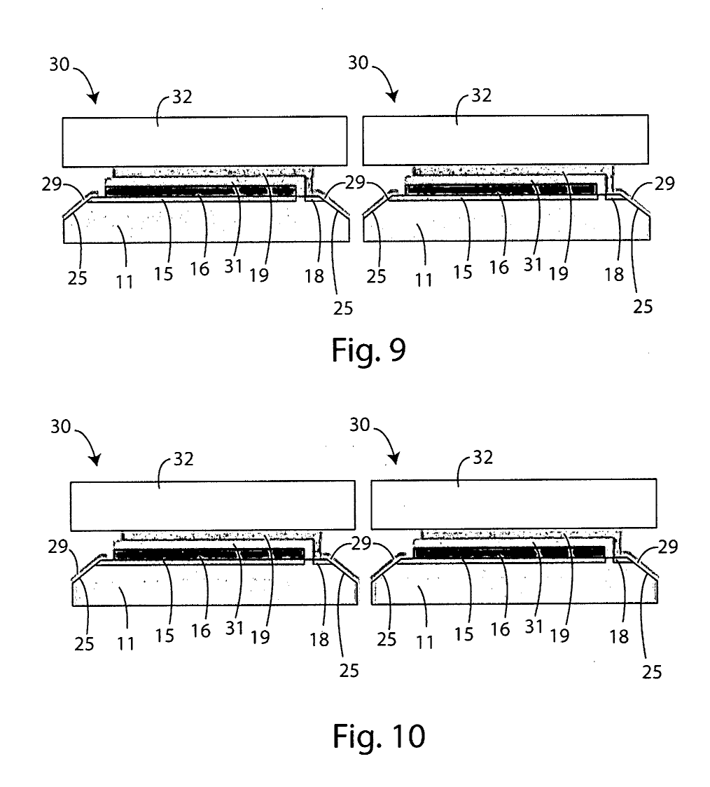

FIG. 9 shows schematically a configuration of electrical and mechanical interconnection of two modules of photoelectrochemical cells according to an eighth embodiment of the present invention,

FIG. 9 shows schematically a configuration of electrical and mechanical interconnection of two modules of photoelectrochemical cells according to a ninth embodiment of the present invention

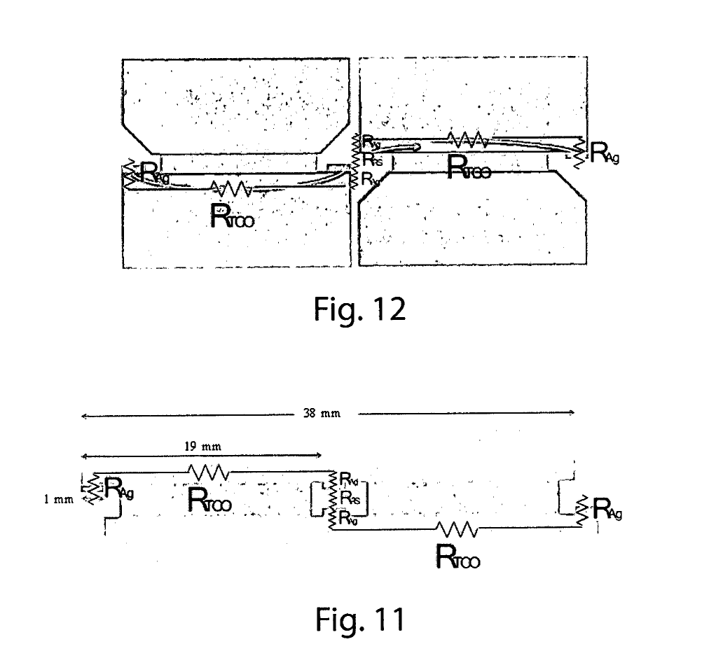

FIG. 11 shows an electrical scheme of the resistances of a configuration of electrical and mechanical interconnection of two modules of photoelectrochemical cells according to the present invention,

FIG. 12 shows an electrical scheme of the resistances of a configuration of electrical and mechanical interconnection of two modules of photoelectrochemical cells according to the present invention,

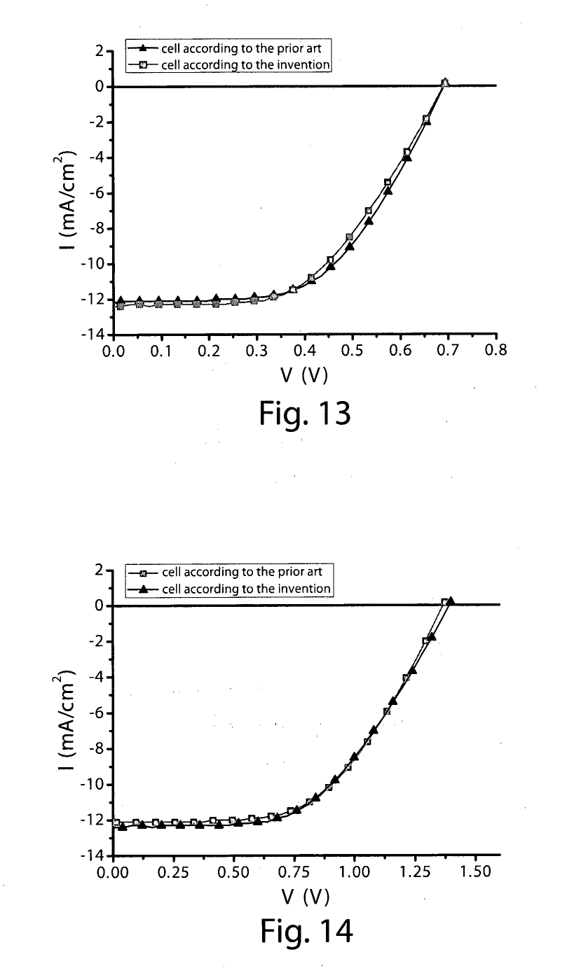

FIG. 13 shows a comparative diagram of I-V plot of the second cell made according to known art compared to the third cell made according to the present invention; and

FIG. 14 shows a comparative diagram of I-V plot of 2-4 cell series connection made according to known art compared with that of 2-3 cell series connection made according to the present invention.

With reference to FIG. 2, wherein for each element of photoelectrochemical cell modules the same numerical references used in the FIG. 1 showing a solution according to known art are used, the proposed solution is based on the disposition of electrode 14 on the side of the photoelectrodes and electrode 17 on the side of the counterelectrodes on the surfaces of the opposing lateral edges of module 10.

In particular, with reference to FIG. 2, two side by side placed modules 10 are shown, with respective substrates 11, 12, between which photoelectrochemical cells 13 are arranged. A first electrode 14, constituting the anode or negative electrode of whole photovoltaic module 10, is realized with a stripe of highly conductive material placed on the lateral edge of first module 10, that in the figure is on the left, and it is electrically connected to the layer of conductive coating 15 of substrate 11 in contact with photoelectrodes 16 of photoelectrochemical cells 13 and it is electrically isolated from the layer of conductive coating 18 of substrate 12 in contact with counterelectrode the 19 of photoelectrochemical cells 13. FIG. 2 shows in fact that the layer of conductive coating 18 of substrate 12 is interrupted before the left lateral edge of the substrate.

On the opposing side, electrode 17 constituting the cathode or positive electrode of first photovoltaic module 10 is again made with a stripe of highly conductive material, placed on the lateral edge that, in FIG. 2, it is on the right of first module 10, and electrically connected to the layer of conductive coating 18 of substrate 12 in contact with counterelectrode 19 of photoelectrochemical cells 13 and it is electrically isolated from the layer of conductive coating 15 of substrate 11 in contact with photoelectrodes 16 of photoelectrochemical cells 13. FIG. 2 shows, in fact, that the layer of conductive coating 15 of substrate 11 is interrupted before of the right lateral edge of the substrate.

FIG. 2 also shows the electrolyte 20 inside of each photoelectrochemical cell 13, as well as the encapsulating material 21 sealing each individual cell, preventing the electrolyte from dispersing.

The electrical and mechanical interconnection between two side by side placed modules is materially carried out connecting electrically and mechanically, by means of welding or interposing of connection element 22 made of conductive resin, or welding with previously tin plated copper and silver ribbon, a first electrode 14, that is the anode, arranged on the lateral edge of a first module 10 with a second electrode 17, that is the cathode, arranged on the lateral edge of second module 10 side by side placed to first, in case of series connection among modules, or a first electrode 14, that is the anode, arranged on the lateral edge of a first module 10 with a second electrode 14, that is the anode, arranged on the lateral edge of second module 10 side by side placed to the first (not reported in FIG. 2) in case parallel connection among modules.

The disposition of electrode 14 on the side of the photoelectrodes and electrode 17 on the side of the counterelectrodes on the opposing lateral edges of module 10 allows useful area to be subtracted to the substrate for the deposition of active areas.

With reference to FIG. 3, a second embodiment of the system of electrical and mechanical interconnection of photoelectrochemical cell modules according to the present invention is shown, wherein one of two substrates 11, 12 of every module 10 is ground, on an edge 23 towards the other substrate, in correspondence of a lateral edge designed to the interconnection with a side by side placed module 10; and the other of two substrates 12,11 is ground in correspondence of the opposing, lateral edge designed to the interconnection with an ulterior module side by side placed, on edge 24 towards the first substrate. In correspondence of substrate 11 the photoelectrode of each photoelectrochemical cell 13 (in the figure a single photoelectrochemical cell 13 is represented) is arranged, while in correspondence of substrate 12 the respective counterelectrodes are arranged. The respective layers of conductive coating 15 and 18 are interrupted in proximity of the correspondent ground edge. Moreover, on the ground edge a silver or other material layer 29 is present allowing the welding of previously tin plated copper and silver ribbon to be carried out, i.e. the interposing of a conductive resin to be more effective. Alternatively, it is possible to allow that the ground surface (as well as that of the lateral edge of substrates) to be rough, for the best adhesion of conductive resin or ribbon.

On not ground edges of the two substrates 11, 12 electrodes 14, 17 are placed, respectively a first electrode 14, constituting the anode or negative electrode of photovoltaic module 10, on the substrate in contact with the photoelectrodes of photoelectrochemical cells 13, and a second electrode 17, constituting the cathode or positive electrode of photovoltaic module 10, in contact with the counterelectrodes of photoelectrochemical cells 13. Every electrode 14, 17 is realized with a stripe of highly conductive material.

The interconnection between two side by side placed modules 10 shown in FIG. 3 is realized by means of a conductive resin, arranged between electrode 14 of first module 10 and electrode 17 of second module 10, assuring mechanical adhesion and electrical connection, allowing series connection between two side by side placed modules 10 to be obtained.

In order to realize a parallel connection between modules it will be instead necessary the modules side by side to be placed so that to approach each to other the respective electrodes 14 of the whole module on the side of the photoelectrodes, that is respective electrodes 17 of the whole module on the side of the counterelectrodes.

With reference to FIG. 4, a third embodiment of the system of electrical and mechanical interconnection of photoelectrochemical cell modules according to the present invention is shown, that is different from that showed with reference to FIG. 3 for the single fact that the silver layer 29 is arranged also on the not ground lateral edges of substrates 11, 12 of side by side placed modules 10.

With reference to FIG. 5, a fourth embodiment of the system of electrical and mechanical interconnection of photoelectrochemical cell modules according to the present invention is shown, wherein both two substrates 11, 12 of every module 10 are ground, on the opposing edges 25, in correspondence of the edges designed to the interconnection with a side by side placed module 10. Also according to this fourth embodiment, in correspondence of substrate 11 the photoelectrode of each photoelectrochemical cell 13 is arranged (in the figure a single photoelectrochemical cell 13 is represented), while in correspondence of substrate 12 the respective counterelectrodes are arranged. Moreover, also in this case, on the ground edges a silver or other material layer 29 is present allowing the welding of previously tin plated copper and silver ribbon to be carried out i.e. the interposing of a conductive resin to be more effective.

In proximity of one of the ground edges 25 of substrate 11 in contact with the photoelectrodes of photoelectrochemical cells 13 a first electrode 14 is present, constituting the anode or negative electrode of whole photovoltaic module 10, the respective layer of conductive coating 15 being interrupted in proximity of the opposing edge.

In the same way on the ground edge of substrate 12 opposing to that of substrate 11 whereon it is positioned said electrode 14 a second electrode 17 is present, constituting the cathode or positive electrode of the whole photovoltaic module 10, in contact with the counterelectrodes of photoelectrochemical cells 13, the respective layer of conductive coating 18 being interrupted in proximity of the opposing edge.

Every electrode 14, 17 is realized with a stripe of highly conductive material.

The interconnection between two side by side placed modules 10 as shown in FIG. 5 is realized by means of a conductive resin, arranged between electrode of first module 10 and electrode 17 of second module 10, assuring mechanical adhesion and electrical connection, allowing series connection between two side by side placed modules 10 to be obtained.

In order to realize a parallel connection between modules it will be instead necessary that the modules side by side to be placed so that to approach each to other the respective electrodes 14 on the side of the photoelectrodes of the cell, that is respective electrodes 17 on the side of the counterelectrodes of the cell.

The double grinding allows to have a channel inside of which it is possible to insert the conductive resin more easily.

With reference to FIG. 6, a fifth embodiment of the system of electrical and mechanical interconnection of photoelectrochemical cell modules according to the present invention is shown, that is different from that showed with reference to FIG. 5 for the single fact that the silver layer 29 is arranged also on the not ground edges of substrates 11, 12 of side by side placed modules 10.

The electrical and mechanical interconnection system of photoelectrochemical cell modules, up to now shown with reference to the interconnection of modules consisting of two conductive substrates, is in the same way applicable to the interconnection of modules consisting of a single conductive substrate, used for photoelectrochemical cells of the so-called monolithic type.

With reference to FIG. 7, two side by side placed modules 30 of monolithic photoelectrochemical cells according to a sixth embodiment of the present invention are shown. In order the existing correspondences between this type of modules and those described with reference to previously described embodiments to be more apparent, the elements previously described for figures relating to previous embodiments will be indicated using the same numerical references.

Modules 30 as shown in FIG. 7 are constituted by a single substrate 11, whose surface is covered with a layer of conductive coating 15 and supporting sequentially a photoanode 16, a spacer 31 realized with an insulating ceramic material and a counterelectrode 19 connected to a portion 18 of conductive coating layer, said surface being separated from the remainder of conductive coating layer 15, and supported on substrate 11, in proximity of a ground edge 24 of substrate 11, whereon a silver stripe 29 is applied. Also a second substrate 32 is shown, which does not have electrical conduction function but only lamination and encapsulation and it is optional.

The interconnection between two side by side placed modules 30 shown in FIG. 7 is realized by means of a conductive resin, placed in the space available due to the grinding, assuring the mechanical adhesion and electrical connection between two side by side placed modules 10.

With reference to FIG. 8, a seventh embodiment of the system of electrical and mechanical interconnection of photoelectrochemical cell modules according to the present invention, relating to two side by side placed modules 30 of monolithic photoelectrochemical cells, is shown. This embodiment is different from that shown with reference to FIG. 7 for the single fact that the silver layer 29 is arranged also on the not ground edges of substrates 11 of side by side placed modules 30.

With reference to FIG. 9, two side by side placed modules 30 of monolithic photoelectrochemical cells according to an eighth embodiment of the present invention are shown, wherein both edges 25 of substrate 11 are ground, on the grinding surface being screen printed a silver stripe 29.

The interconnection between two side by side placed modules 30 as shown in FIG. 9 is realized by means of a conductive resin, placed in the space available due to the grinding, assuring the mechanical adhesion and electrical connection between two side by side placed modules 30.

With reference to FIG. 10 a ninth embodiment of the system of electrical and mechanical interconnection of photoelectrochemical cell modules according to the present invention, relating to two side by side placed modules 30 of monolithic photoelectrochemical cells, is shown. This embodiment is different from that shown with reference to FIG. 9 for the single fact that the silver layer 29 is arranged also on the not ground edges of substrates 11 of side by side placed modules 30.

.In order to allow the characteristics of the electrical and mechanical interconnection system of modules of electrochemical cells according to the present invention to be checked, samples according to the embodiment as described with reference to FIG. 3 have been constructed. The realization steps of the samples and the results of tests the same have been subjected to are reassumed in the following examples.

### EXAMPLE 1

The produced samples have been obtained form conductive glass substrates (TCO) with dimensions measuring 46 mm of length, 17 mm of width and 3.2 mm of height. These values are determined using as starting point the dimensions of the used active area of the cells (9 mm), the dimensions of encapsulating material outside of the cells (3 mm) and the dimensions of the grinding area (1 mm) obtainable with commercially available apparatus.

The grindings have been carried out with an angle of 45° on a single edge of every substrate (according to the embodiment as described with reference to FIG. 3).

Successively the substrates has been scribed, using laser ablation on every substrate, in correspondence of the side whereon the grinding had been carried out.

Then the electrodes of the module have been realized, by the deposition, using screen printing technique, of a silver paste track for every substrate, and subsequent sintering at 525° C. over 30 min.

Then on one of two substrates, using screen printing technique, the deposition of photoelectrode material (porous TiO₂), successively sintered at 525° C. for 30 mink has been carried out, while on the other substrate, again using screen printing technique, the deposition of the counterelectrode material (platinum), successively sintered to 480° C. for 15 min, has been carried out. The modules used as samples are realized with a single photoelectrochemical cell, in order the evaluation of characteristic parameters thereof to be easier.

Then the two substrates have been coupled, realizing the closing of the cell. Photoelectrode and counterelectrode have been sealed using thermoplastic materials. finally liquid electrolyte has been inserted.

After the modules have been constructed in such a way, the same have been interconnected by means of placement of a conductive resin assuring the mechanical adhesion and electrical connection.

The distance between the two cells of the two modules side by side placed and interconnected by means of the system of interconnection which is object of the present invention is measured and it was from 0.5 mm to 1 mm, such variation depending on the realization of single cell, obtained using manual procedures for grinding and substrate alignment of the screen printer. It Is easy apparent that by means of an automatic grinding it would be possible to have a distance between cells reduced also lower than 0.5 mmm.

Also the substantially perfect planarity between the two cells is verified.

### EXAMPLE 2

Successively the comparison between the systems of interconnection according to the present invention and according to known art, in particular analyzing the series resistance of single sample module and a plurality of sample modules interconnected according to said two technologies. For this purpose samples without active area (that is without photoelectrochemical cells) are realized, i.e. comprising the single lateral electrodes of the whole module, and resistances thereof have been estimated. FIGS. 5 and 6 show respectively a schematic view of the structure and electrical scheme of the resistances of an electrical and mechanical interconnection configuration of two modules of photoelectrochemical cells according to known art and present invention.

With reference to FIGS. 5 and 6, for every thus realized sample, the series resistance (R_{S}) is given by the resistance of silver (R_{Ag}) and resistance of the conductive coating of the substrate (R_{TCO}), according to the formula

Rs=R_{Ag}+R_{TCO}+R_{Ag}

Table 1 shows the series resistance values as measured for six representative samples of the modules of known art, according to the scheme shown in FIG. 5:

TABLE 1

| Sample | Series resistance (Ω) |
|---|---|
| 1 | 2.23 |
| 2 | 2.42 |
| 3 | 2.38 |
| 4 | 2.47 |
| 5 | 2.41 |
| 6 | 2.53 |
| Average | 2.41 |

while table 2 shows the series resistance values as measured for six representative samples of the modules of the present invention, according to the scheme shown in FIG. 6:

TABLE 2

| Sample | Series resistance (Ω) |
|---|---|
| 1 | 2.22 |
| 2 | 2.78 |
| 3 | 2.42 |
| 4 | 2.54 |
| 5 | 2.56 |
| 6 | 2.60 |
| Average | 2.52 |

Again with reference to FIGS. 11 and 12, the series resistance (Rₜₒₜ) of the connection of two samples, is represented by the sum of the resistance contributions from silver electrodes (R_{Ag}), conductive coating of the substrates (R_{TCO}) of the two side by side placed modules and connection resistance of the two devices using conductive resin (R_{RS}), according to the formula:

Rₜₒₜ=R_{Ag}+R_{TCO}+R_{Ag}+R_{RS}+R_{Ag}+R_{TCO}+R_{Ag}

Table 3 shows the series resistance values as measured for two samples obtained by means of interconnection of two modules selected from six representative samples of the modules of the known art, according to the scheme shown in FIG. 5:

TABLE 3

| Samples | Series resistance (Ω) | Contact resistance (Ω) |
|---|---|---|
| 2 + 4 | 4.92 | 0.03 |
| 5 + 6 | 4.96 | 0.02 |
| Average | 4.94 | 0.025 |

while table 4 shows the series resistance values as measured for two samples obtained by means of interconnection of two modules selected from nine representative samples of the modules of the present invention, according to the scheme shown in FIG. 6:

TABLE 4

| Samples | Series resistance (Ω) | Contact resistance (Ω) |
|---|---|---|
| 1 + 6 | 4.83 | 0.01 |
| 3 + 5 | 5.01 | 0.03 |
| Average | 4.92 | 0.02 |

The comparison of the data from tables 2 and 4 shows that the resistance average values of the samples of two interconnected modules, made, respectively, according to the known art and the present invention are completely analogous and both display very reduced values for contact resistance.

### EXAMPLE 3

The successive step has been the realization of samples obtained through the interconnection of modules of complete electrochemical cells, that is comprising also photoelectrochemical cells. Tables 5 and 6 show the characteristic respective parameters as measured respectively for cells made according to the known art and the present invention.

TABLE 5

| | Efficiency | Isc | | |
|---|---|---|---|---|
| | (%) | (mA/cm2) | Voc (v) | FF (%) |
| 1 | 4.80 | −13.0 | 6.90E−1 | 53.67 |
| 2 | 4.65 | −12.0 | 6.95E−1 | 55.55 |
| 3 | 4.78 | −12.7 | 6.95E−1 | 54.41 |
| 4 | 4.58 | −12.5 | 6.79E−1 | 53.89 |
| 5 | 4.32 | −11.3 | 6.81E−1 | 56.27 |
| 6 | 4.39 | −11.9 | 6.76E−1 | 54.79 |
| Average | 4.59 | −12.2 | 6.86E−1 | 54.76 |

TABLE 6

| | Efficiency | Isc | | |
|---|---|---|---|---|
| | (%) | (mA/cm2) | Voc (v) | FF (%) |
| 1 | 4.60 | −13.0 | 7.05E−1 | 50.12 |
| 2 | 4.53 | −12.1 | 7.06E−1 | 52.99 |
| 3 | 4.48 | −12.3 | 6.94E−1 | 52.34 |
| 4 | 4.39 | −11.7 | 7.08E−1 | 52.96 |
| 5 | 4.20 | −12.4 | 6.96E−1 | 48.50 |
| 6 | 4.44 | −11.4 | 7.07E−1 | 55.21 |
| Average | 4.44 | −12.2 | 7.03E−1 | 52.02 |

Tables 5 and 6 show that the electrical parameters of the electrochemical cells made according to the two types of connection have analogous values corresponding to acceptable percentages variations. Table 7 shows the percentage differences for the values of characteristic electrical parameters measured for cells made according to the known art and the present invention

TABLE 7

| | Efficiency | Isc | | |
|---|---|---|---|---|
| | (%) | (mA/cm2) | Voc (v) | FF (%) |
| Comparison | −3.2% | 0% | +2.4% | −5% |

The value of FF −5% between type with not and staggered glasses is increased due a Voc greater for staggered glasses, otherwise it would be −3%.

FIG. 13, showing a comparative diagram of I-V plot of the second cell realized according to the known art (data from table 5) compared to third cell realized according to the present invention (data from table 6), makes more apparent the nearly perfect correspondence among the values obtainable according to said two different technologies.

Tables 8 and 9 show the characteristic electrical parameters as measured, for series connection of cells made according to the known art and the present invention respectively.

TABLE 8

| | | Isc | | |
|---|---|---|---|---|
| Cells | Efficiency (%) | (mA/cm2) | Voc (V) | FF (%) |
| 2-4 | 4.23 | −12.2 | 1.38 | 51.65 |

TABLE 9

| | | Isc | | |
|---|---|---|---|---|
| Cells | Efficiency (%) | (mA/cm2) | Voc (V) | FF (%) |
| 2-3 | 4.22 | −12.5 | 1.39 | 51.62 |

FIG. 14 shows a comparative diagram of I-V plot of the series connection of cells 2-4 realized according to the known art (data from table 5) and the series connection of cells 2-3 realized according to the present invention (data from table 6) and it makes apparent that the two voltage-current characteristics are completely analogous.

Below aperture ratio and transparency characteristics of a photovoltaic module DSSC of known type, consisting of 7 cells being 17.2 cm long and 0.9 cm wide series connected and conductive grids placed on the sides of the substrates each having a width of approximately 0.5 cm are compared to a DSSC photovoltaic module which is the object of the invention, consisting of 17.2 cm×0.9 cm sized 7 series connected 7 cells and conductive grids placed on the edges of substrates.

The known art photovoltaic module is characterized by the following parameters:
Total area 186.9 cm²
Active area: 108.36 cm²
Aperture ratio: 58%
   where the total area is the sum of two areas, a first 169.1 cm² area consisting of active plus sealing areas, and a second 17.8 cm² consisting of conductive grids placed on the edges of substrates.

The photovoltaic module which is the object of the present invention displays the following parameters:
Total area 169.1 cm²
Active area: 108.36 cm²
Aperture ratio: 64%
   As it can be seen, the parameter of aperture ratio is improved for six percentage units.

In the know art module, the presence of the conductive grids on the sides of the substrate increases the dimensions of the total area. This area is a passive area because it does not contribute to the photovoltaic effect.

Considering the power generated under standard test conditions (STC) i.e. 0.6 Watt as the power produced from a photovoltaic module, an efficiency of active area of 5.6% is obtained.

For the known art device, multiplying such efficiency by the value of aperture ratio, a percentage of total efficiency of approximately 3.25% is obtained, while for the device which is the object of the invention, multiplying such efficiency by the value of the aperture ratio, a percentage of total efficiency of 3.58% is obtained, therefore higher than known art device by approximately nine percentage units.

From the point of view of the transparency of the photovoltaic device, the conductive grids placed on the lateral edges of the substrate allow the photovoltaic device to display a more uniform transparency than when the grids are placed on sides of the substrate.

This is apparent if a parameter identifying the percentage ratio between transparent and not transparent area of a photovoltaic module is considered, defining as transparent area the active area (that is the area occupied by the cells) and the occupied area by sealing material.

For a given transparent area, approximately 163 cm², for the photovoltaic module of known art type, this ratio is 90%, while for the photovoltaic module which is the object of the invention this ratio is 96%, with an improvement of total transparency of the photovoltaic module of approximately 6%.

### EXAMPLE 4

In addition tests for mechanical and electrical resistance vs temperature comparing samples realized with the connection system of photoelectrochemical cell modules according to the known art and the present invention have been carried out

Table 10 shows the results of the measure of ultimate tensile stress in N/mm² by means of three point bending tests for samples realized according to the known art and the present invention. The samples, consisting of the interconnection of two cells, are positioned on an appropriate two point support, next to the edge of the samples, and in the middle a third point exerts a force so as to flex the sample until the failure. In this way it is possible to calculate the interconnection supported maximum load. The tests have carried out using 20 mm wide and 40 mm long samples, with 20 mm×6.2 mm (width×thickness of the sample) interconnection section. The maximum failure load has been measured at 25° C., 80° C. and 110° C., and moreover again at 25° C. after heating the sample at 140° C. Under all the thermal stress conditions the mechanical behaviour of the samples obtained using the interconnection system according to the present invention proved to be better than according to the known art. Also a decrement of maximum ultimate tensile load with temperature increase for both the techniques, because of the intrinsic behaviour of interconnecting material as temperature function. Further for both the techniques it has been observed that, after thermal stress and cooling the samples at 25° C. (room temperature) the mechanical resistance proved to be improved compared to the initial value, because of the improved adhesion of the interconnecting material.

TABLE 10

| | Ultimate | Ultimate tensile | Improvement of |
|---|---|---|---|
| | tensile strength | strength for | failure strength for |
| | for known art | present | present invention |
| | sample | invention | compared to known |
| | (N/mm²) | sample (N/mm²) | art (%) |
| T = 25 C.° | 5.54 | 9.5 | +71.5% |
| T = 8 C.° | 3.5 | 4.5 | +28.6% |
| T = 110 C.° | 0.5 | 1.5 | +200.0% |
| T = 25 C.° | 9.2 | 14.0 | +52.2% |
| (after heating at | | | |
| 140° C.) | | | |

The present invention allows modules with substantially straight lateral edges to be realized. This characteristic allows an higher automatic assembling capability of substrates, since the substrate alignment can be carried out by placing the substrate lateral edges suitable to be beaten.

An ulterior advantage of the present invention is to provide a module shape less sensitive to the interaction with the external environment, thus facilitating a greater resistance to the module aging, since there are no portions of substrate coated with conductive oxide exposed to the external environment.

An further advantage of the present invention is to offer a better mechanical resistance than known art.

The present invention has been described by an illustrative, but not limitative way, according to preferred embodiments thereof, but it is to be understood that variations and/or modifications can be carried out by those skilled in the art without departing from the scope thereof as defined according to the attached claims.

1. A module of photoelectrochemical cells, comprising at least a flat shape substrate, with two opposing surfaces and a lateral edge, joining said opposing surfaces along the respective perimeters, on one of said surfaces of said substrate being placed in succession a conductive coating and one or more photoelectrochemical cells, said module comprising moreover a first electrode of the whole module and a second electrode of the whole module, wherein said substrate has on at least a portion of said lateral edge, means for electrical connection and rigid planar mechanical coupling with a side by side placed module of the same type.

2. The module of photoelectrochemical according to claim 1 comprising a first substrate and a second substrate, respectively equipped, on mutually opposing surfaces, with a first layer of conductive coating of said first substrate and second layer of conductive coating of said second substrate, between which one or more photoelectrochemical cells are arranged, a first electrode of the whole module, electrically connected to said first layer of conductive coating and electrically isolated from said second layer of conductive coating and second electrode of the whole module, electrically connected to said second layer of conductive coating and electrically isolated from said first layer of conductive coating, wherein said first substrate and said second substrate are coupled facing each other with the respective lateral edges aligned, defining a module with substantially straight lateral edges, said means of electrical connection and rigid planar mechanical coupling with a side by side placed module of the same type comprising said first electrode of the whole module and said second electrode of the whole module placed on two opposing portions of said lateral edge of said module.

3. The module of photoelectrochemical cells according to claim 1, wherein that said means of electrical connection and rigid planar mechanical coupling with a side by side placed module of the same type on said lateral edge comprises at least a portion of said lateral edge of said at least one substrate with a bevelled edge.

4. The module of photoelectrochemical cells according to claim 1, wherein said means of electrical connection and mechanical coupling with a side by side placed module of the same type on said lateral edge involves that said at least one substrate has a silver or other material suitable as an adjuvant for welding of a ribbon of copper or tin plated silver or for interposing a conductive resin.

5. The module of photoelectrochemical cells according to claim 1, wherein said means of electrical connection and mechanical coupling with a side by side placed module of the same type on said lateral edge involves that said at least one substrate has a wrinkled portion on said lateral edge and/or at least a ground edge.

6. An Electrical and mechanical interconnection system of photoelectrochemical cell modules, according to claim 1, wherein the lateral edge on a portion of which is arranged an electrode of a first module is rigidly mechanically coupled with the lateral edge on a portion of which is arranged an electrode of a second side by side placed module to said first module along a portion of said lateral edge, that can coincide or not with said portion whereon is arranged said electrode, thus series or parallel connecting both electrically and mechanically said side by side placed modules, constituting a rigid planar structure of side by side placed modules.

7. The electrical and mechanical interconnection system of photoelectrochemical cell modules according to claim 6, wherein said electrical and mechanical connection among said modules side by side placed along the respective lateral edges is constituted by welded material or by a connection element made of conductive resin or metal, arranged among lateral edges of said side by side placed modules.

8. The electrical and mechanical interconnection system of photoelectrochemical cell modules according to claim 7, wherein said metal connection element is a ribbon of copper or tin plated silver welded by joule effect or magnetic induction or according to equivalent technique.
